(19) United States
(12) Patent Application Publication
(10) Pub. No.: US 2021/0073664 A1
(43) Pub. Date: Mar. 11, 2021

(54) SMART PROFICIENCY ANALYSIS FOR ADAPTIVE LEARNING PLATFORMS

(71) Applicant: INTERNATIONAL BUSINESS MACHINES CORPORATION, Armonk, NY (US)

(72) Inventors: Sushain Pandit, Austin, TX (US); Su Liu, Austin, TX (US); Fang Wang, Westford, MA (US); Martin Oberhofer, Sindelfingen (DE)

(21) Appl. No.: 16/565,555

(22) Filed: Sep. 10, 2019

(51) Int. Cl. G06N 5/04; G06N 20/00

(52) U.S. Cl. CPC G06N 5/046; G06N 20/00

(57) ABSTRACT

A method, a computer system, and a computer program product for adaptive learning is provided. Embodiments of the present invention may include combining a plurality of users of an adaptive learning platform into one or more clusters based on an initial questionnaire. Embodiments of the present invention may include monitoring key events of the plurality of users, wherein the key events are indicative of a level of comprehension of a topic for the plurality of users. Embodiments of the present invention may include adjusting the combination of the plurality of users in the one or more clusters based on the key events. Embodiments of the present invention may include adjusting the initial questionnaire.

### BACKGROUND

The present invention relates generally to the field of computing, and more particularly to adaptive learning. Adaptive learning platforms are increasing in popularity as alternative educational methods for students. Traditional classroom learning may be augmented by adaptive learning platforms. Typical adaptive learning platforms may use a data-driven, non-linear approach to student learning by adjusting a student's demonstrated performance level.

### SUMMARY

Embodiments of the present invention disclose a method, a computer system, and a computer program product for adaptive learning. Embodiments of the present invention may include combining a plurality of users of an adaptive learning platform into one or more clusters based on an initial questionnaire. Embodiments of the present invention may include monitoring key events of the plurality of users, wherein the key events are indicative of a level of comprehension of a topic for the plurality of users. Embodiments of the present invention may include adjusting the combination of the plurality of users in the one or more clusters based on the key events. Embodiments of the present invention may include adjusting the initial questionnaire.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for adaptive learning using smart proficiency analysis according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

As previously described, adaptive learning platforms are increasing in popularity as alternative educational methods for students. Traditional classroom learning may be augmented by adaptive learning platforms. Typical adaptive learning platforms may use a data-driven, non-linear approach to student learning by adjusting a student's demonstrated performance level. Additionally, traditional adaptive learning platforms learn about a student by tracking the progress of the student using selective assignment sets over time. Selective assignments over time allows students to learn at their own pace with customized progression plans.

Many adaptive learning platforms also incorporate performance measures or proficiency tests on a regular basis to identify where a student is struggling with a subject, when to move the student to the next assignment and how to adapt the learning structure to align with the abilities of the student. For example, traditional adaptive learning platforms will ensure that a student fully understands a topic by moving on to the next topic if the student has answered a specified number of problems in a row correctly. Additionally, an initial test may be used to create a student profile to tailor the student's learning experience without adjustments to the profile which creates a narrow learning experience for the student. Therefore, it may be advantageous to, among other things, build a dynamic adaptive learning platform that will analyze a series of student interactions and inputs that take the student from an incorrect answer to a correct answer, as opposed to only analyzing the final answer.

The following described exemplary embodiments provide a system, method and program product for adaptive learning. As such, embodiments of the present invention have the capacity to improve the field of adaptive learning by building a dynamic adaptive learning system, method and program product that analyzes various student inputs to improve student proficiency in a subject or topic. More specifically, the dynamic adaptive learning process will analyze students by quantifying a series of inputs that a student may provide to go from a wrong answer to a correct answer and by identifying and analyzing interactions from a set of students. Students may also be known as users or a user. A benefit of the dynamic adaptive learning process is that the analysis is based on actions and key events by a set of students within a specific question. Key events may be indicative of a student's comprehension of a subject or a topic. Analysis of one or more student actions based on each specific question provides a deeper assessment than traditional methods by identifying and interpreting student behavior regarding each question individually.

According to an embodiment, an initial profile may be created. The initial profile may be based on an initial questionnaire that asks several characterizing questions. Characterizing questions may be related to the user, the user's academic background, age or topic being tested. The information provided by the user and received by an adaptive learning program may be based on the initial questionnaire and may be analyzed using natural language processing (NLP) and semantic analysis or probabilistic latent semantic indexing (PLSI). Based on the initial analysis, an initial cluster of users may be formed using NLP analysis, semantic analysis or PLSI analysis. Additionally, clustering algorithms may be used, such as k means clustering algorithm.

The initial questionnaire may be given to users in various formats, such as multiple-choice questions, short answer questions such as a sentence explaining the answer or long answer questions such as one or more paragraphs explaining the answer. The information provided by the user may be provided in the form of structured or unstructured data. Both structured data and unstructured data may be received by an adaptive learning program based on the questionnaire. Structured data may include data that is highly organized, such as multiple-choice answers to questions, a spreadsheet, relational database or data that is stored in a fixed field. Unstructured data may include data that is not organized and has an unconventional internal structure, such as a portable document format (PDF), an image, a presentation, a webpage, video content, audio content, an email, a word processing document or multimedia content.

Based on the type of data being received by the adaptive learning program, NLP or semantic analysis or PLSI may be used for analysis. Answers provided by the users may include multiple choice answers or textual inputs answering questions that require sentences. A user may also provide answers verbally or non-verbally, such as spoken answers captured by a microphone to answer the questionnaire inquiries or responses provided by answering the questions on a computer by typing in the multiple-choice answer or the sentence to respond. NLP may be used to extract information from the user responses that are meaningful to create a user profile. Semantic analysis or PLSI may be used to evaluate the questionnaire answers, consider syntactic structures and to associate a weight or a score to the provided answers and to infer meaning to the user's phrases, sentences and paragraphs.

The initial profile may be used to cluster the students or to organize the students into one or more groups. A set of student interactions in an adaptive learning environment is identified based on the initial profiles. The identified student interactions may be received and stored on a database or a knowledgebase for analysis. Student interactions may include, for example, how many times one or more students with a similar initial profile refer to a help screen, click on a hint button, watch a related video or answer the question incorrectly. Additional student interactions may include how much time a student is idle between viewing a hint and answering the question. Student interactions may also include a student choosing a partially correct answer or a student gravitating towards a specific wrong answer on a question.

According to an embodiment, the student interactions may be identified for the purpose of improving student proficiency by analyzing, via an analysis module (i.e., smart proficiency analysis module), an initial assessment or questionnaire, student feedback, curriculum topics, curriculum questions, hints viewed by students, answers by students and profile clusters. Based on the analysis, the initial profile may be adjusted by adjusting the initial profile questionnaire for an updated and more accurate clustering. The analysis and updated clustering may be used to create or improve the help or hint sections for the students in certain profiles or clusters. The analysis may also be used to provide feedback to content publishers to improve the content delivery of the questions.

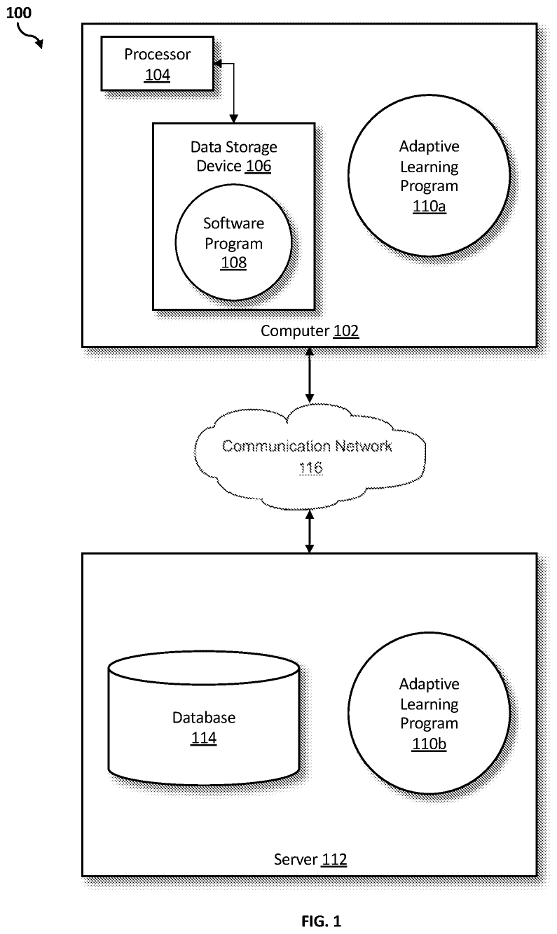

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an adaptive learning program 110a. The networked computer environment 100 may also include a server 112 that is enabled to run an adaptive learning program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

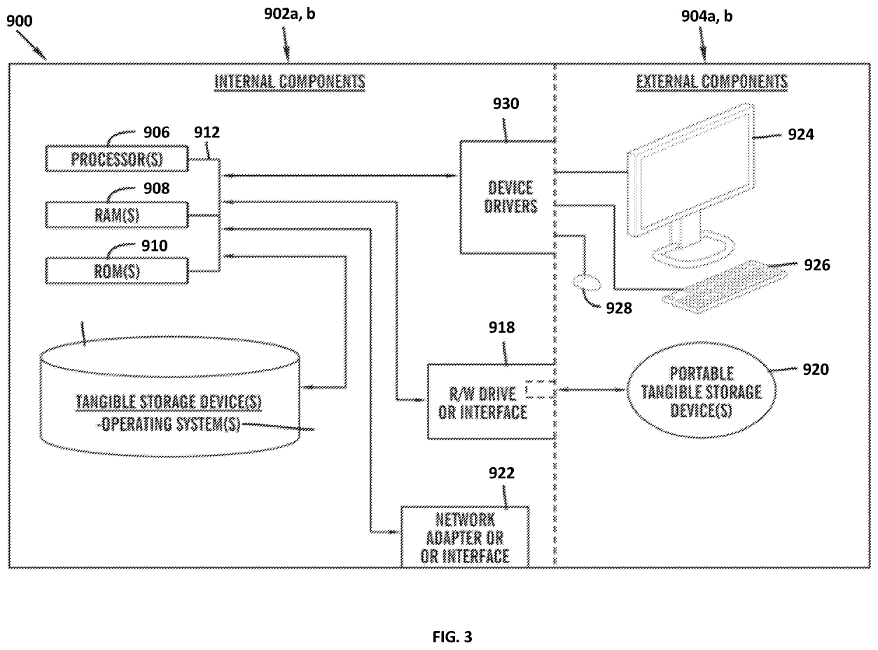

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Blockchain as a Service (BaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the adaptive learning program 110a, 110b may interact with a database 114 that may be embedded in various storage devices, such as, but not limited to a computer/mobile device 102, a networked server 112, or a cloud storage service.

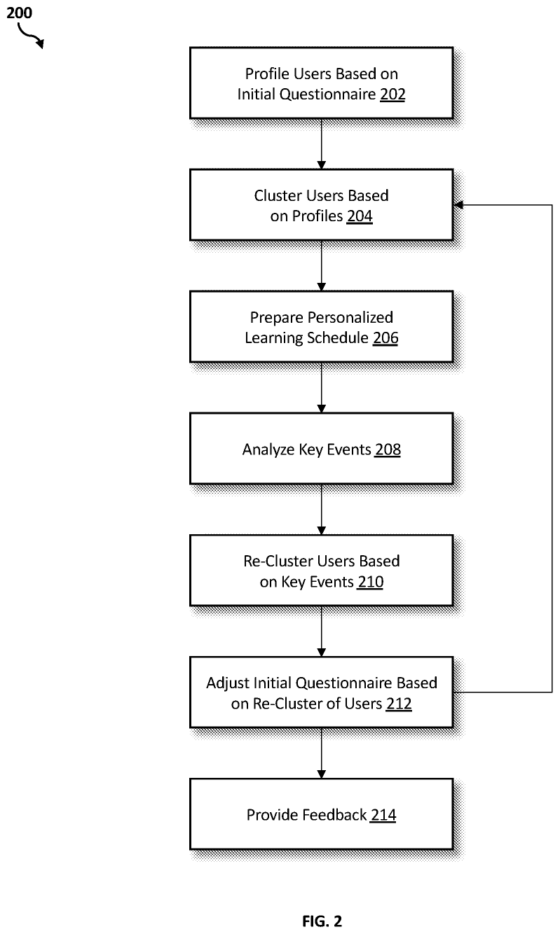

According to the present embodiment, a user using a client computer 102 or a server computer 112 may use the adaptive learning program 110a, 110b (respectively) to quantify user inputs for analysis. The adaptive learning method is explained in more detail below with respect to FIG. 2.

Referring now to FIG. 2, an operational flowchart illustrating the exemplary smart proficiency adaptive learning process 200 used by the adaptive learning program 110a, 110b according to at least one embodiment is depicted.

At 202, users are profiled based on an initial questionnaire. The initial questionnaire may ask characterizing questions in order to cluster the users or students. Characterizing questions may include, for example, inquiring the user's age or to select an age range, intelligent quotient (IQ) or questions that may ascertain the IQ of the user, emotional quotient (EQ) or questions to ascertain the EQ of the user or grade level or questions to ascertain a grade level. Inputs captured by the adaptive learning program 110a, 110b in response to the initial questionnaire may be in the form of multiple-choice questions or textual input. A score may be given to each user based on the user's answers to the questionnaire and NLP may be used to analyze textual inputs from the user. Profiles are created based on the received user information, such as age or age range, an IQ level, EQ level, grade level or the number of pre-requisites obtained.

At 204, users are clustered based on the profiles. The initial profile created at step 202 may be used to cluster the students into a grouping. The grouping may be created by using the responses to the questionnaire and mapping the responses to a feature vector. The questionnaire answers and related scores may be used to form a set of features that may be used to form the initial clusters. The initial clusters may be created, for example, using a k means clustering algorithm or Lloyd's algorithm. For example, k number of clusters may be initialized to 5 students out of 100, whichever is more. Each created cluster may be the basis for a personalized learning schedule for each student within the cluster. Semantic analysis, PLSI and NLP may also be used to analyze the questionnaires and to cluster the users based on the users' profiles.

At 206, personalized learning schedules are prepared. The personalized learning schedule for each student may be monitored at the individual student level even if a group of individual students are in the same cluster. Monitoring may be done by identifying key events of each student that may indicate a behavior of a set of students whether the students are in the same or similar profile or in different profiles. Key events may be captured based on the user or student interaction with the adaptive learning program 110a, 110b. User interaction may include user behaviors in relation to each question provided by the adaptive learning program 110a, 110b, such as time spent on a question and features used, such as a student clicking on a button to receive a hint or help for a question and still getting the answer wrong after receiving a hint or help.

At 208, key events are analyzed. A key event is an event that indicates student interaction or a behavior of a student that may be received, for example, when a student is logged into the adaptive learning program 110a, 110b interface application and the student is interacting with the program via clicking various features provided. For example, features used by a student include the student responding to a question by clicking on or providing an answer, by inquiring about a hint, by asking for help, by checking an answer, by the amount of time idle while on a question or by continuously choosing a specific incorrect answer even after viewing hints.

For example, if a set of students within the same initial profile keep referring to a help screen by clicking on the hint button or watching a related video in the application, then the key event will be added to an analysis queue. In addition to the key events, the analysis queue will be used to store and analyze other student activities, such as whether the student answered the question correctly after receiving a hint, idle time spend between viewing the hint and answering the question and if the students are prone towards choosing an incorrect answer regardless of the hint, help or videos related to the question.

Analysis of the key events that have been added to the analysis queue may include, for example, analyzing if the student used a hint (i.e., yes=1, no=0), how long it took for the student to respond to the question without a hint and how long it took for the student to respond to the question using the hint. A scheduler may be used to trigger the analysis module to begin the processing of the key events loaded into the key event queue. A trigger may include, for example, when a predetermined number of events have occurred, such as a value greater than or equal to 500 events. The key event queue may capture key events in order to analyze the key events that may be the catalyst to augment the initial questionnaire or initial static feature set of questions with additional attributes that represent student responses.

At 210, users are re-clustered based on key events. A profile re-clustering module may determine whether a profile cluster requires re-clustering or to be re-divided based on the key event analysis. Profile re-clustering may include further dividing of a cluster based on a subset of the initial profile cluster interacting with a question in a certain manner. The profile re-clustering module may use revised feature vectors to recompute cluster centroids. Revised future vectors may include, for example, a combination of static data features from questionnaires and dynamic data features from key events. The combined or unified feature vector may be used to re-cluster the user profiles.

Recomputing cluster centroids may lead to incremental adjustments to the profile questionnaires. For example, within profile cluster A, two subgroups emerged. One subgroup is answering the question correctly and the other subgroup is answering the question incorrectly even after viewing the hint. The analysis module may take each key event from the key event queue into consideration and perform a profile re-clustering based on the unified feature vectors.

The profile re-clustering module may operate using multiple analysis layers beginning with the feature attributes (e.g., age, IQ and pre-requisites) that were used to define the initial profile clusters created at step 204. The feature attributes may be augmented with additional attributes that capture one or more students' responses (e.g., response, wait time and hint used) to questions that are being added to the key events queue. Based on the captured feature attributes and the additional attributes, a unified feature vector is created, and the unified featured vector may be used to re-cluster the students based on the key events (e.g., age, IQ, pre-requisites, response, wait time and hint used). For example, {12, 119, {1,2}, 30, 0} would translate to a student who is 12 years old with an IQ of 119 who took pre-requisite courses numbered 1 and 2, who responded with option #2, who took a pause of 30 seconds to arrive at the answer and who did not use the hint.

The next analysis layer of the profile re-clustering module may include using the re-clustered data to come up with or create a dataset based on student responses by analyzing the key events queue. The dataset may contain several instances that would be similar to the re-clustered data. A clustering algorithm, such as k-means clustering, may be used over the dataset to compute one or more centroids and each centroid may represent a new or an existing cluster. The re-clustering module may, using the dataset and centroids, determine if the new centroids match the original set and if not, the new centroids may be labeled and stored as new clusters.

At 212, the initial questionnaire is adjusted based on the re-cluster of users. The re-clustered groups or subgroups, based on a re-clustering analysis, may have adjustments made to the initial questionnaires. Adjustments made may add more questions or modify the order of the questions that may lead to a more accurate clustering for future initial questionnaires. Re-clustering analysis may include a feedback loop that evolves over time to reach a stage where the questionnaire begins to cluster the students with a high amount of clustering accuracy during the initial questionnaire. The re-clustering analysis feedback loop may also evolve more quickly or over time if more students use the platform (i.e., more training and analysis data).

For example, if the outcome of the re-clustering at step 210 created newly assigned profile clusters and the number of the newly assigned profile clusters is greater than a pre-determined threshold (e.g., 10), then the adaptive learning program 110a, 110b may divide or further divide the initial profile questionnaire that was used in step 202 based on the newly discovered centroids during the re-clustering process. If the outcome of the re-clustering at step 210 did not create newly assigned profile clusters or if the new profile clusters are under the pre-determined threshold, then the adaptive learning program 110a, 110b may not amend the initial profile questionnaire and may keep the initial profile questionnaire as is.

At 214, feedback is provided. Feedback may be provided to various people, institutions or companies. Feedback may be based on a history of re-clustering actions used to create a causal chain of why re-clustering occurred at step 210. Additionally, questionnaire adjustments from step 212 may be shared. Subsequent impacts of re-clustering or questionnaire adjustments, or both, as to whether or not the re-clustering or adjustments resulted in reaching a steady state may also be shared. Subsequent impacts of the adaptive learning program 110a, 110b in a steady state may show that there was no need to re-cluster the students further.

For example, feedback regarding the key event analysis of the time spend on a hint and whether a partial or fully correct answer was chosen may be transmitted to the curriculum developers for the purposes of improving the questions. Feedback or output from the profile re-clustering module may include, for example, feedback to curriculum developers for the purpose of improving the questions and the hints provided to users based on an analysis of the key events.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the adaptive learning program 110a in client computer 102, and the adaptive learning program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the adaptive learning program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the adaptive learning program 110a in client computer 102 and the adaptive learning program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the adaptive learning program 110a in client computer 102 and the adaptive learning program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

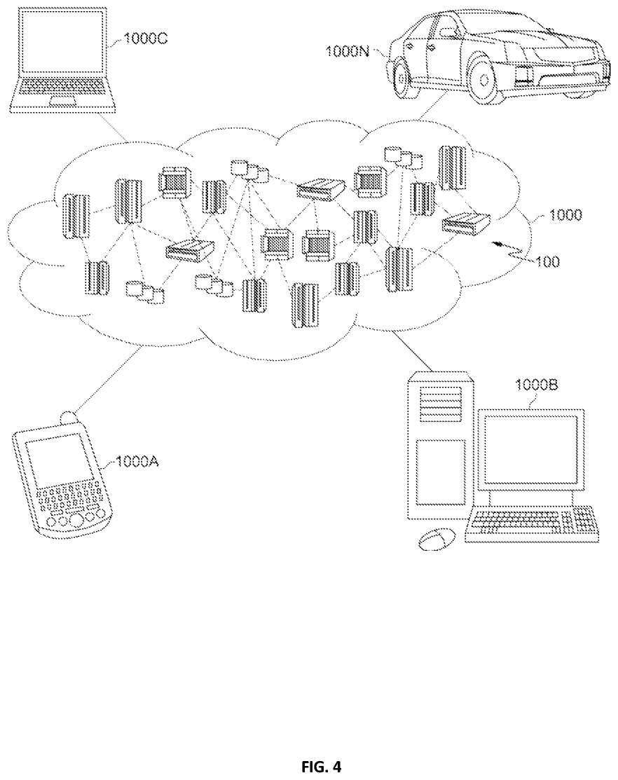

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

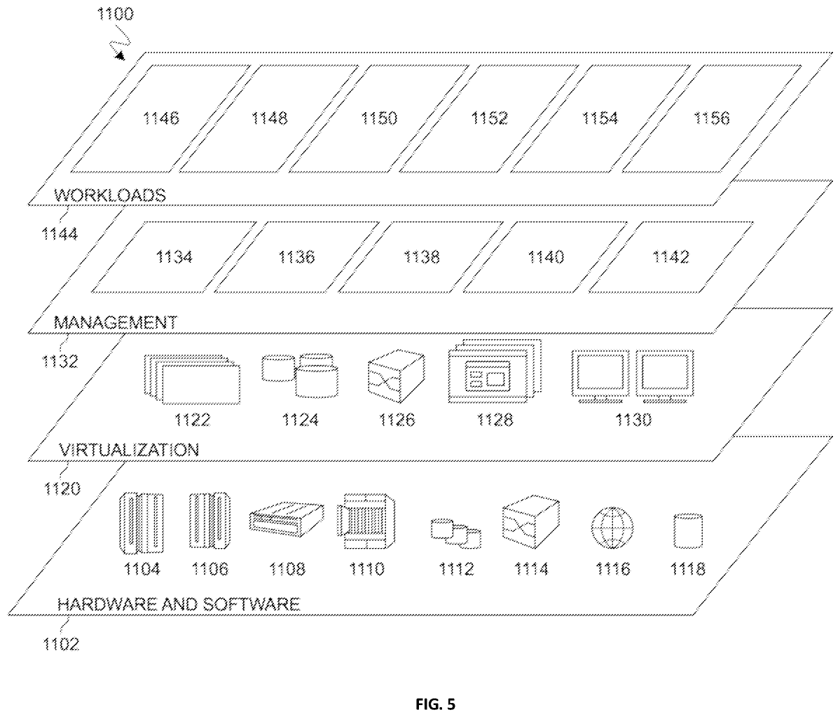

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and adaptive learning 1156. An adaptive learning program 110a, 110b provides a way to improve student proficiency in various topics.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
combining a plurality of users of an adaptive learning platform into one or more clusters based on an initial questionnaire;
monitoring key events of the plurality of users, wherein the key events are indicative of a level of comprehension of a topic for the plurality of users;
analyzing and adjusting the combination of the plurality of users in the one or more clusters based on the key events; and
adjusting the initial questionnaire.

2. The method of claim 1, further comprising:
providing feedback to curriculum developers for an improvement of adaptive learning platform questions.

3. The method of claim 1, wherein the one or more clusters are based on a result of the initial questionnaire, wherein the result of the initial questionnaire is used to create a user profile.

4. The method of claim 1, wherein the key events are based on a user's interaction with the adaptive learning platform, wherein the key events include a user's answer to a question, a user's inquiry about a hint or a user's amount of time spent on the question.

5. The method of claim 1, wherein adjusting the combination of the plurality of users creates a re-clustering of the users, wherein the re-clustering of the users include further dividing the one or more clusters based on an analysis of the key events, wherein the re-clustering includes using a revised feature vector analysis to recompute cluster centroids.

6. The method of claim 1, wherein the initial questionnaire includes questions relating to a user's age, a user's grade level, a user's prerequisite courses, intelligent quotient (IQ) level and emotional quotient (EQ) level.

7. The method of claim 1, wherein the adjusted questionnaire is based on re-clustered groups of users and subgroups of users, wherein the adjusted questionnaire is a modified version of the initial questionnaire, where the modified version of the initial questionnaire include more questions, less questions or modified questions for a next round of users.

8. A computer system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
combining a plurality of users of an adaptive learning platform into one or more clusters based on an initial questionnaire;
monitoring key events of the plurality of users, wherein the key events are indicative of a level of comprehension of a topic for the plurality of users;
adjusting the combination of the plurality of users in the one or more clusters based on the key events; and
adjusting the initial questionnaire.

9. The computer system of claim 8, further comprising:
providing feedback to curriculum developers for an improvement of adaptive learning platform questions.

10. The computer system of claim 8, wherein the one or more clusters are based on a result of the initial questionnaire, wherein the result of the initial questionnaire is used to create a user profile.

11. The computer system of claim 8, wherein the key events are based on a user's interaction with the adaptive learning platform, wherein the key events include a user's answer to a question, a user's inquiry about a hint or a user's amount of time spent on the question.

12. The computer system of claim 8, wherein adjusting the combination of the plurality of users creates a re-clustering of the users, wherein the re-clustering of the users include further dividing the one or more clusters based on an analysis of the key events, wherein the re-clustering includes using a revised feature vector analysis to recompute cluster centroids.

13. The computer system of claim 8, wherein the initial questionnaire includes questions relating to a user's age, a user's grade level, a user's prerequisite courses, intelligent quotient (IQ) level and emotional quotient (EQ) level.

14. The computer system of claim 8, wherein the adjusted questionnaire is based on re-clustered groups of users and subgroups of users, wherein the adjusted questionnaire is a modified version of the initial questionnaire, where the modified version of the initial questionnaire include more questions, less questions or modified questions for a next round of users.

15. A computer program product comprising:
one or more computer-readable tangible storage media and program instructions stored on at least one of the one or more computer-readable tangible storage media, the program instructions executable by a processor to cause the processor to perform a method comprising:
combining a plurality of users of an adaptive learning platform into one or more clusters based on an initial questionnaire;
monitoring key events of the plurality of users, wherein the key events are indicative of a level of comprehension of a topic for the plurality of users;
adjusting the combination of the plurality of users in the one or more clusters based on the key events; and
adjusting the initial questionnaire.

16. The computer program product of claim 15, further comprising:
providing feedback to curriculum developers for an improvement of adaptive learning platform questions.

17. The computer program product of claim 15, wherein the one or more clusters are based on a result of the initial questionnaire, wherein the result of the initial questionnaire is used to create a user profile.

18. The computer program product of claim 15, wherein the key events are based on a user's interaction with the adaptive learning platform, wherein the key events include a user's answer to a question, a user's inquiry about a hint or a user's amount of time spent on the question.

19. The computer program product of claim 15, wherein adjusting the combination of the plurality of users creates a re-clustering of the users, wherein the re-clustering of the users include further dividing the one or more clusters based on an analysis of the key events, wherein the re-clustering includes using a revised feature vector analysis to recompute cluster centroids.

20. The computer program product of claim 15, wherein the initial questionnaire includes questions relating to a user's age, a user's grade level, a user's prerequisite courses, intelligent quotient (IQ) level and emotional quotient (EQ) level.
